(19) United States
(12) Patent Application Publication
(10) Pub. No.: US 2026/0117049 A1
(43) Pub. Date: Apr. 30, 2026

(54) IMPACT DISSIPATING MATERIAL AND METHOD OF MANUFACTURE

(71) Applicant: Worcester Polytechnic Institute, Worcester, MA (US)

(72) Inventors: Diana A. Lados, Holden, MA (US); Anthony G. Spangenberger, Worcester, MA (US); Mircea D. Pascovici, Bucharest (RO)

(73) Assignee: Worcester Polytechnic Institute, Worcester, MA (US)

(21) Appl. No.: 19/374,924

(22) Filed: Oct. 30, 2025

Related U.S. Application Data
(60) Provisional application No. 63/714,191, filed on Oct. 31, 2024.

(51) Int. Cl. C08K 7/22; C08K 11/00

(52) U.S. Cl. CPC C08K 7/22; C08K 11/00

(57) ABSTRACT

An impact dissipating material comprises a matrix material defining a plurality of cells and an interpenetrating material carried by the matrix material. The interpenetrating material is disposed in a first position relative to the plurality of cells of the matrix material under a first loading condition and in a second position relative to the plurality of cells under a second loading condition. The combination of the matrix material and the interpenetrating material defines the overall impact response of the impact dissipating material.

### RELATED APPLICATIONS

This patent application claims the benefit of U.S. Provisional Application No. 63/714,191 filed on Oct. 31, 2024 and entitled “Fluid-Foam Impact Absorber,” the contents and teachings of which are hereby incorporated by reference in their entirety.

### BACKGROUND

Many engineered devices are designed with impact-absorbing systems that dissipate kinetic energy to shielded systems such as protect equipment, payloads, and/or vehicle occupants. For example, impact-absorbing systems can be incorporated as part of aircraft and automotive crush structures and shock absorbers, military vehicle shielding, shipping container protection, and personal protective equipment.

In conventional applications, developers can take a variety of metrics into consideration when designing an impact-absorbing system, such as metrics which enable both high strength and energy absorption with low component weight. For example, developers can consider peak transmitted stress/force, specific strength (e.g., strength-to-weight ratio), and specific energy absorption (e.g., energy absorbed per unit mass) when designing impact-absorbing systems. Developers can also tailor the amount of stress transmitted by the impact-absorbing system to the shielded system as required by standards and engineering requirements.

### SUMMARY

Conventional impact-absorbing systems suffer from a variety of deficiencies. For example, typical impact-absorbing systems are manufactured from elastomeric or polymeric materials which define the impact response of the impact-absorbing systems. As such, while developers can tailor the amount of stress dissipated by the impact-absorbing system, this can be limited based upon the properties of the elastomeric or polymetric materials available and utilized. Further, conventional elastomeric or polymeric materials have a relatively compliant response when exposed to an impact load. As such, developers can be limited when relatively stiffer impact responses are needed.

By contrast to conventional impact-absorbing materials, embodiments of the present innovation relate to an impact dissipating material and method of manufacture. In one arrangement, the impact dissipating material is configured as an interpenetrating, synergistic composite that includes a matrix material defining a plurality of cells and an interpenetrating material carried by the matrix material. When exposed to a loading condition, the interpenetrating material is configured to flow relative to the cells defined by the matrix material. As such, the impact dissipating characteristics of the impact dissipating material are dependent upon the material properties of both the matrix material and the interpenetrating material and structural characteristics of the matrix material. Accordingly, with such a configuration, a developer can customize both the matrix material and the interpenetrating material to define a particular impact response of the composite material.

Further with the use of both a matrix material and an interpenetrating material to define the impact dissipating characteristics of the impact dissipating material, unconventional materials can be utilized as the matrix material. For example, designers can use metallic materials as the matrix material to define the cellular structure of the composite material. Metallic materials have an inherently stiffer response relative to elastomers. As such, the use of the metallic matrix materials with interpenetrating materials provides the developer with the ability to define a particular impact response of the composite material, based upon an expected impact response.

Embodiments of the innovation relate to an impact dissipating material, comprising a matrix material defining a plurality of cells and an interpenetrating material carried by the matrix material. The interpenetrating material is disposed in a first position relative to the plurality of cells of the matrix material under a first loading condition and in a second position relative to the plurality of cells under a second loading condition. The combination of the matrix material and the interpenetrating material defines the overall impact response of the impact dissipating material.

An impact dissipation system, comprising: a base; and an impact dissipating material carried by the base, the impact dissipating material comprising: a matrix material defining a plurality of cells; and an interpenetrating material carried by the matrix material, the interpenetrating material disposed in a first position relative to the plurality of cells of the matrix material under a first loading condition and in a second position relative to the plurality of cells under a second loading condition.

Embodiments of the innovation relate to a method of manufacturing an impact dissipating material while preserving a wall structure defining each cell of a matrix material, comprising: fluidizing an interpenetrating material to reduce a viscosity of the interpenetrating material from a first viscosity value to a second viscosity value; applying the interpenetrating material to the matrix material; and adjusting the viscosity of the interpenetrating material from the second viscosity value to the first viscosity value.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 illustrates an exploded schematic representation of an impact dissipation system having an impact dissipating material, according to one arrangement.

FIG. 2A illustrates a first side sectional schematic representation of an impact dissipating material, according to one arrangement.

FIG. 2B illustrates a second side sectional schematic representation of the impact dissipating material of FIG. 2B, according to one arrangement.

FIG. 3A illustrates a sectional view of an impact dissipating material prior to compression, according to one arrangement.

FIG. 3B illustrates a perspective view of the impact dissipating material prior to compression, according to one arrangement.

FIG. 4A illustrates a sectional view of an impact dissipating material of FIG. 2A after compression, according to one arrangement.

FIG. 4B illustrates a perspective view of the impact dissipating material of FIG. 3B after compression, according to one arrangement.

FIG. 5 illustrates a schematic representation of an impact dissipating material having an interpenetrating material configured as a field-responsive material, according to one arrangement.

FIG. 6 illustrates a schematic representation of an impact dissipating material having an interpenetrating material configured as a field-responsive material, according to one arrangement.

FIG. 7 illustrates a side sectional schematic representation of an impact dissipating material, according to one arrangement.

FIG. 8 is a flowchart illustrating a method of manufacturing an impact dissipating material, according to one arrangement.

FIG. 9 illustrates example mechanical test data showing force-time profiles experienced by an object protected by an impact dissipating material, according to one arrangement.

### DETAILED DESCRIPTION

Embodiments of the present innovation relate to an impact dissipating material and method of manufacture. In one arrangement, the impact dissipating material is configured as an interpenetrating, synergistic composite that includes a matrix material defining a plurality of cells and an interpenetrating material carried by the matrix material. When exposed to a loading condition, the interpenetrating material is configured to flow relative to the cells of the matrix material. As such, the impact dissipating characteristics of the impact dissipating material are dependent upon the material properties of both the matrix material and the interpenetrating material and structural characteristics of the matrix material. Accordingly, a developer can customize both the matrix material and the interpenetrating material to define a particular impact response of the composite material.

Further with the use of both a matrix material and an interpenetrating material to define the impact dissipating characteristics of the impact dissipating material, unconventional materials can be utilized as the matrix material. For example, designers can use metallic materials as the matrix material to define the cellular structure of the composite material. Metallic materials have an inherently stiffer response relative to elastomers. As such, the use of the metallic matrix materials with interpenetrating materials provides the developer with the ability define a particular impact response of the composite material, based upon an expected impact response.

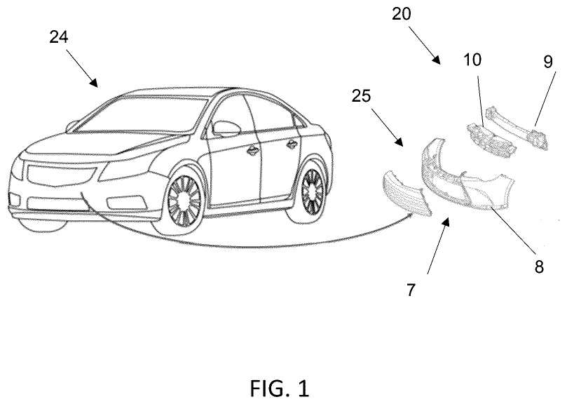

FIG. 1 illustrates an example of an impact dissipation system 20 having an impact dissipating material 10, according to one arrangement. The impact dissipation system 20 can be utilized as part of a variety of devices. For example, the impact dissipation system 20 can be configured as a bumper 25 of an automobile 24, as shown. However, the impact dissipation system 20 can be configured in a variety of ways, such as, but not limited to, aerospace honeycomb structures, protective athletic gear, infrastructure such as highway guard rails, and cargo packaging.

As shown, the impact dissipation system 20 includes a base or shell 7, such as a bumper cover 8 and impact bar 9, and an impact dissipating material 10 carried by the base 7 and configured as the impact-dissipating layer of the impact dissipation system 20. The impact dissipating material 10 provides improvements to the impact response metrics of conventional devices, while preserving control of transmitted stresses. As such, in the example shown in FIG. 1, the impact-absorbing properties of the bumper 25 can be improved by replacement with the impact dissipation system 20 having the impact dissipating material 10.

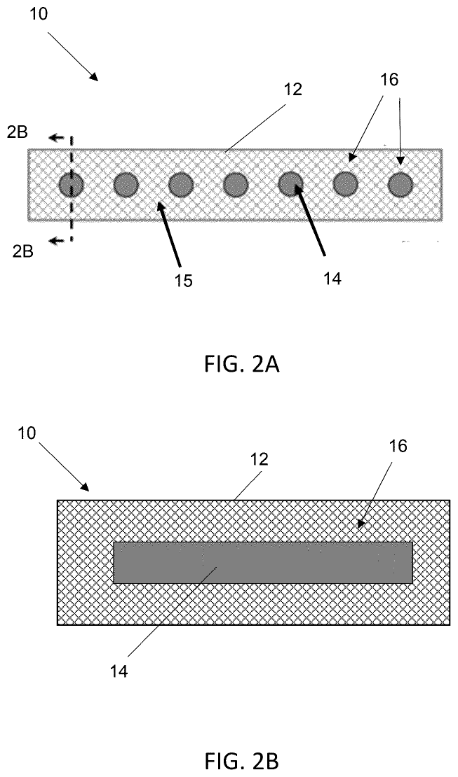

FIGS. 2A and 2B illustrate a schematic representation of the impact dissipating material 10, according to one arrangement. The impact dissipating material 10 is a composite material/system that includes a matrix material 12 defining a plurality of cells 15 and an interpenetrating material 14 carried by the matrix material 12. The combination of the matrix material 12 and the interpenetrating material 14 defines the overall impact response of the impact dissipating material 10, thereby enhancing the impact-absorbing properties of an impact dissipation system 20.

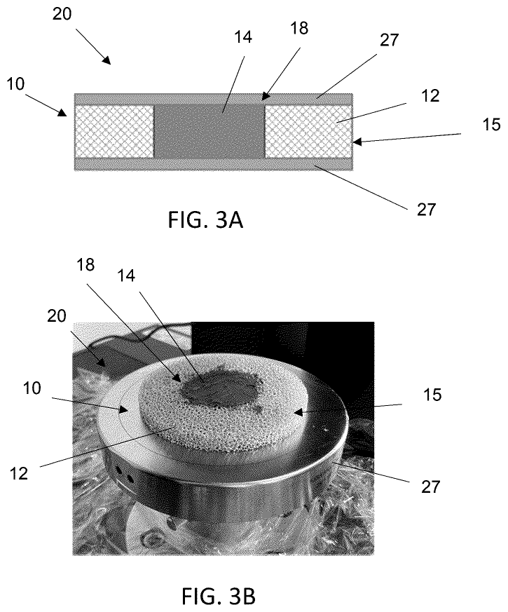

In one arrangement, the interpenetrating material 14 is configured to flow relative to the matrix material 12 during application of an impact load to the impact dissipation system 20. For example, with reference to FIGS. 3A and 3B, under a first loading condition, such as in the absence of an impact load, the interpenetrating material 14 is disposed in a first position relative to the plurality of cells 15 of the matrix material 12. With such loading and positioning, the matrix material 12 constrains the interpenetrating material 14 in a relatively steady-state position relative to the cells 15.

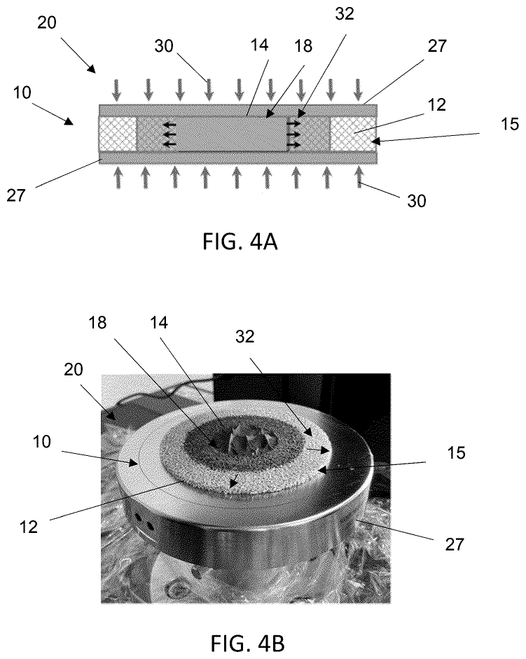

With additional reference to FIGS. 4A and 4B, when the impact dissipating material 10 is disposed between two supports 27, such as the bumper cover 8 and impact bar 9 shown in FIG. 1, upon application of a second loading condition, such as compressive impact load 30 normal to a plane of the impact dissipating material 10, the interpenetrating material 14 extrudes through the matrix material 12 via the cells 15, such as in a linear or radial direction 32 from the impact load 30, to a second position relative to the plurality of cells 15. The interpenetrating material 14 augments the impact-absorbing function of the matrix material 12 with added energy-dissipating frictional and viscoelastic/viscoplastic squeeze-flow of the interpenetrating material 14 through the plurality of cells 15 of the matrix material 12. As such, the material properties of the matrix material 12, the geometry of the cellular structure of the matrix material 12, and the flow of the interpenetrating material 14 through the matrix material 12 defines the overall impact response of the impact dissipating material 10.

Returning to FIGS. 2A and 2B, the matrix material 12 can be configured in a variety of ways.

In one arrangement, the matrix material 12 can be manufactured from a variety of materials. For example, the matrix material 12 can be manufactured from a metallic material, such as an aluminum 6101-T6 foam or from a polymeric foam material. The relative density of the foam, pore size of the cells 15, and ligament strength of the matrix material 12 can be selected to control the baseline strength of the matrix material 12 and degree of strengthening via the amount of relative density, surface area, and pore size/shape.

In one arrangement, the matrix material 12 can be configured as a stochastic structure where the cells 15 are sized and shaped in a random or unpredictable manner. In such an arrangement, the stochastic matrix material 12 can define the plurality of cells 15 as open cell structures where the cells 15 interconnect with each other and are not fully enclosed. For example, open cell structures can be found in a matrix material 12 configured as an open cell foam. Further, the matrix material 12 can define the plurality of cells 15 as closed cell structures where each individual cell of the plurality of cells 15 materials are completely sealed and form a non-porous barrier. Additionally, the matrix material 12 can define the plurality of cells 15 as a combination of open cell structures and closed cell structures. For example, the matrix material 12 can be configured as a predominantly open-cell foam having localized cavities or closed pores that are filled with the interpenetrating material 14.

In one arrangement, the stochastic matrix material 12 can be configured as a gradient structure wherein the size of the cells 15 gradually changes (e.g., increases or decreases) along an axis of the impact dissipating material 10, such as along a radial direction 32 relative to a location of an expected impact load, or along an axis of the applied impact load 30.

In one arrangement, the matrix material 12 can be configured as an architected structure where the cells 15 are sized and shaped in a precise and repeatable manner. As such, the function of the architected matrix material 12 derives not only from the constitutive material but also from its geometry. For example, the architected matrix material 12 can be configured as honeycomb structures, which promote high directional strength-to-weight ratio, negative Poisson ratio structures, which contract on compression (e.g., as opposed to conventional expansion), that can enhance fluid-structure interactions, or as flow-preserving structures that are designed to collapse locally throughout the matrix material 12 while preserving other flow channels that collapse only at higher strain levels. Further the architected matrix material 12 can be configured as reversibly compressible materials, such as obtained using snap-through ligament designs, chiral structures, or other such designs or as self-reinforcing materials, such as arrayed Tesla valves, in which fluid conduits are designed such that fluid flow is redirected back at itself by baffles incorporated in the matrix material 12.

In such an arrangement, the architected matrix material 12 can define the plurality of cells 15 as open cell structures where the cells 15 interconnect with each other and are not fully enclosed. For example, open cell structures can be found in a matrix material 12 configured as an open cell lattice. Further, the matrix material 12 can define the plurality of cells 15 as closed cell structures where each individual cell of the plurality of cells 15 materials are completely sealed and form a non-porous barrier. Additionally, the matrix material 12 can define the plurality of cells 15 as a combination of open cell structures and closed cell structures. For example, the matrix material 12 can be configured as a predominantly open-cell foam having localized cavities or closed pores that are filled with the interpenetrating material 14. In one arrangement, the architected matrix material 12 can be configured as a gradient structure wherein the size of the cells 15 gradually changes (e.g., increases or decreases) along an axis of the impact dissipating material 10, such as along a radial direction 32 relative to a location of an expected impact load, or along an axis of the applied impact load 30.

In one arrangement, the structure of the matrix material 12 can also be engineered using additive manufacturing methods for enhanced overall performance of the impact dissipating material 10. For example, design of the cellular lattices enables production of impact dissipating materials 10 that derive functional properties from their structures, such as auxetic materials with negative Poisson ratio, anisotropic strengths, and flow channel design to control strengthening due to squeeze flow.

The interpenetrating material 14 can be selected or intelligently designed to allow for a synergy with the matrix material 12, thereby providing the impact dissipating material 10 with a particular impact response. As such, the interpenetrating material 14 can be configured in a variety of ways, as provided below.

In one arrangement, the interpenetrating material 14 can be configured as a viscous fluid. For example, the interpenetrating material 14 can be configured as a granular paste or a relatively high-viscosity grease.

In one arrangement, the interpenetrating material 14 can be configured as a shear thickening fluid that can undergo an increase in viscosity or phase transformation under the application of an external stimulus, such as a critical shear rate, the level of which can be controlled as a design parameter through the constitutive makeup of the fluid. For example, the interpenetrating material 14 can be configured as a yield stress fluid with Bingham behavior. With such a configuration, when exposed to a relatively low stress the interpenetrating material 14 behaves like a solid material. However, once the yield stress of the interpenetrating material 14 is exceeded, the interpenetrating material 14 behaves (e.g., flows) like a liquid material.

In one arrangement, the interpenetrating material 14 can be configured as a viscoelastic and/or viscoplastic fluid disposed within the matrix material 12. For example, the interpenetrating material 14 can be configured as a viscoelastic network polymer. In one arrangement, the interpenetrating material 14 can be configured as a viscoelastic solid disposed within the matrix material 12.

In one arrangement, the rheology of the interpenetrating materials 14 used in the impact dissipating material 10 can be modified, such as by the addition of reinforcing or functional particles. Interpenetrating materials 14 having shear-thinning, shear-thickening, electro- and magneto-rheologic characteristics, and phase-change fluids possessing a flow/yield stress can each provide a distinct performance response of the impact dissipating material 10.

For example, the interpenetrating material 14 can be configured with a designed fluid characteristic, such as by being customized via varied processing methods and/or reinforcement with particles. For example, the interpenetrating material 14 can include strengthening mechanisms, such as particles or polymer chains. The strengthening mechanisms are configured to adjust a flow characteristic of the interpenetrating material 14 relative to the matrix material 12, such as caused by collisional/frictional interactions between particles, viscous drag of particles in the interpenetrating material 14, and/or entanglement/network formation of the polymer chains. In one arrangement the interpenetrating material 14 is configured to undergo various mechanistic transitions with the surface chemistry of the participating species and their respective volume fractions, which can enhance overall impact-absorption behavior of the impact dissipating material 10. In one arrangement, the mechanical performance of the interpenetrating material 14 is configured to resist degradation over time (e.g., reduction of energy-dissipating ability due to degradation with time and environmental exposure).

In one arrangement, the interpenetrating material 14 is configured as a smart fluid or field-responsive material where the mechanical properties of the interpenetrating material 14 can be dynamically changed (e.g., of time-varied throughout an impact event) by controlling an external field applied to the impact dissipating material 10. With such a dynamic change, the external field can vary the resistance of the interpenetrating material 14 in a non-constant way throughout an individual impact event and, as such, can be used to lower the peak force/acceleration experienced by the impact dissipating material 10 and, thereby, whiplash-type effects.

In the case where the interpenetrating material 14 of the impact dissipating material 10 is configured as a magneto-rheologic or electro-rheologic fluid, the fluid properties of the interpenetrating material 14 can be actively controlled using a magnetic field or electric field, respectively. The impact dissipating material 10 can also be configured as a magneto-rheologic elastomer, such as polyurethane foam having dispersed carbonyl iron particles. With such a configuration, when exposed to a magnetic field, the interpenetrating material 14 can increase in stiffness.

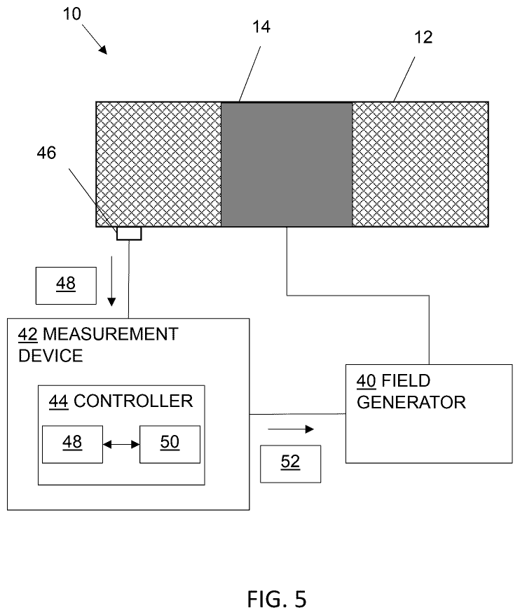

For example, and with reference to FIG. 5, the interpenetrating material 14 of the impact dissipating material 10 is disposed in electrical communication with a field generator 40, such as an electrical field generator or a magnetic field generator. The field generator 40 is configured to dynamically adjust the stiffness of the interpenetrating material 14 such that the synergistic behavior of the combination of the matrix material 12 and the interpenetrating material 14 defines a given physical response in the presence of an impact load. For example, the application of a relatively stronger electric or magnetic field to the interpenetrating material 14 can increase the relative stiffness of the impact dissipating material 10 while the application of a relatively weaker electric or magnetic field to the interpenetrating material 14 can decrease the relative stiffness of the impact dissipating material 10.

In one arrangement, the field generator 40 is configured to dynamically adjust the stiffness of the interpenetrating material 14 during application of an impact load 30. For example, the field generator 40 can be disposed in electrical communication with the interpenetrating material 14 of impact dissipating material 10. Further, the field generator 40 can be disposed in electrical communication with a load measurement device 42 having a controller, such as a memory and processor.

During operation, the load measurement device 42 is configured to receive a load signal 48 from a load sensor 46 associated with the impact dissipating material 10. For example, as an impact absorber 20 receives an impact load 30, the load sensor 46 can generate and transmit a load signal 48 to the field generator 40 where the load signal 48 is proportional to the impact load 30 experienced by the impact dissipating material 10. The controller 44 of the load measurement device 42 is configured to compare a value of the load signal 48 to an adjustment threshold value 50. In the case where the value of the load signal 48 meets or exceeds the adjustment threshold value 50, the controller can generate and transmit an adjustment signal 52 to the field generator 40. In response to the adjustment signal 52, the field generator 40 can adjust the electrical or magnetic field provided to the interpenetrating material 14 to adjust the stiffness of the impact dissipating material 10 based on the impact load 30 (e.g., making the impact dissipating material 10 either stiffer or more compliant).

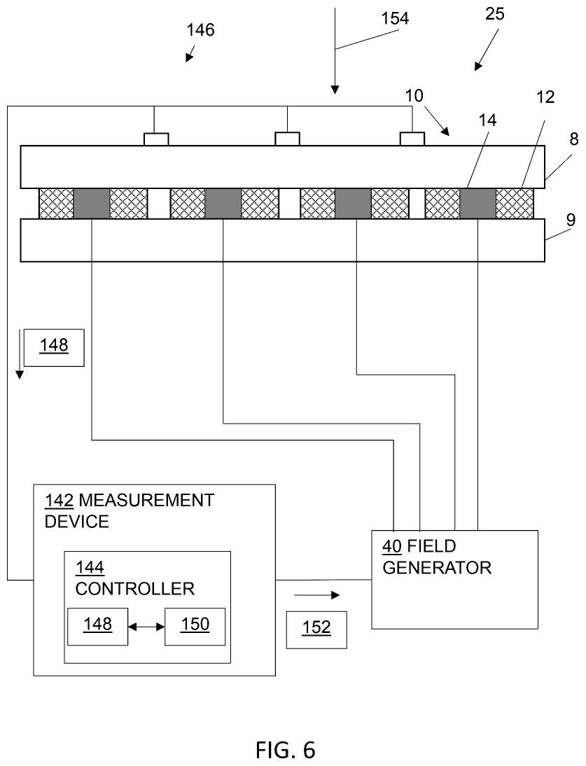

In another example, with reference to FIG. 6, the impact dissipation system 20 can include a plurality of sensors 146 (e.g., radar, tachometer), such as carried by the impact dissipation system 20, configured to identify collision speeds/angles/locations associated with the impact dissipation system 20 before the event. In one arrangement, the impact dissipation system 20 includes a plurality of impact dissipating material 10 elements where the interpenetrating material 14 of each impact dissipating material 10 element is configured as a magneto-rheologic or electro-rheologic fluid. The interpenetrating material 14 of each of the impact dissipating material 10 elements is disposed in electrical communication with a field generator 40, such as an electric field generator or a magnetic field generator. As shown, the impact dissipation system 20 is configured as a bumper 25 having a bumper cover 8 and impact bar 9 with the plurality of impact dissipating material 10 elements disposed therebetween.

The field generator 40 is configured to dynamically adjust the stiffness of the interpenetrating material 14 of each impact dissipating material 10 element individually to spatially vary the stiffness of the impact dissipation system 20 to direct the impact energy. For example, in the event of a collision or impact load 154, a measurement device 142 is configured to receive load signals 148 from each of the sensors 146. The controller 144 of the load measurement device 42 is configured to compare a value of each of the load signals 148 to an adjustment threshold value 150. In the case where the value of the load signal 148 meets or exceeds the adjustment threshold value 150, the controller 144 can generate and transmit an adjustment signal 152 to the field generator 40. In response to the adjustment signal 152, the field generator 40 can adjust the electric or magnetic field provided to the interpenetrating material 14 of one or more of the impact dissipating material 10 elements to adjust the stiffness based on the impact load 154 (e.g., making the impact dissipating material 10 either stiffer or more compliant). For example, the field generator 40 can stiffen the interpenetrating material 14 of the outer impact dissipating material 10 elements to direct the impact energy away from the center of the automobile (e.g., where the occupants are located) and onto the automobile frame.

In one arrangement, the interpenetrating material 14 be further functionalized to provide a visual integrity indicator. For example, in the case where the impact dissipation system 20 is utilized as part of protective athletic gear 22, the interpenetrating material 14 can incorporate a color changing mechanism configured to change the color of the impact dissipating material 10 when exposed to a particular stress or energy level. As such, the impact dissipating material 10 can be used for concussion monitoring in protective athletic gear 22, such as in football or bicycle helmets. Alternately, the impact dissipating material 10 can be used to identify the presence of damage in the protective athletic gear 22, thereby requiring replacement.

As provided above, the interpenetrating material 14 is carried by the matrix material 12. The interpenetrating material 14 can be carried by the matrix material 12 in a variety of ways. For example, in the case where the interpenetrating material 14 is configured as a relatively low viscosity fluid, the matrix material 12 can define a geometry configured to maintain the interpenetrating material 14 in a first (e.g., non-exuded) position relative to the plurality of cells 15 of the matrix material 12 under the first loading condition (e.g., in the absence of an impact load 30).

In one arrangement, as shown in FIGS. 2A and 2B, the matrix material 12 can define one or more cavities 16, such as a periodic array of cavities 16, where each cavity 16 is filled with the interpenetrating material 14. For example, each cavity 16 can be defined by the matrix material 12 as an annular enclosure having its inner section filled with the interpenetrating material 14. In another example, and as shown in FIGS. 3A-4B, the matrix material 12 can define a single annular (e.g., “puck”) enclosure 18 filled with the interpenetrating material 14. With such a configuration of the matrix material 12

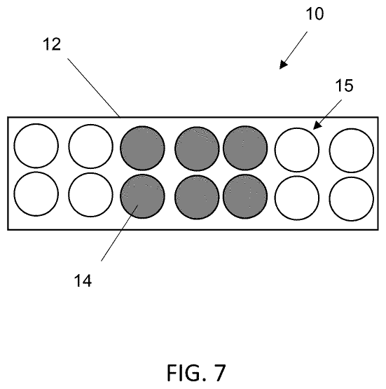

In another arrangement, as shown in FIG. 7, the interpenetrating material 14 may be encapsulated by a portion of the cells 15 defined by the matrix material 12. For example, in the case where the matrix material 12 is created through a 3D printing process, certain cells 15 defined by the matrix material 12 can be built, filled with the interpenetrating material 14, and further enclosed to define enclosed volumes of interpenetrating material 14. In one arrangement, the encapsulated regions of cells 15 can be designed to rupture upon application of an impact load 30, thereby creating a controlled release of the interpenetrating material 14 through the matrix material and imparting its strengthening effect. In one arrangement, the encapsulated regions of cells 15 can be designed to remain intact upon application of an impact load 30, thereby imparting a viscous damping to the impact load 30.

In another example, in the case where the interpenetrating material 14 is configured as a relatively high viscosity fluid, the viscosity or surface tension of the interpenetrating material 14 carried by the matrix material 12 maintains the interpenetrating material 12 in the first (e.g., non-exuded) position relative to the plurality of cells 15 of the matrix material 12 under the first loading condition (e.g., in the absence of an impact load 30). As such, in one arrangement, the interpenetrating material 14 can be distributed within an open-cell structure of the matrix material 12.

As provided above, the material properties of the matrix material 12, the geometry of the cellular structure of the matrix material 12, and the flow of the interpenetrating material 14 through the matrix material 12 define the overall impact response of the impact dissipating material 10. In one arrangement, the fill ratio of the interpenetrating material 14 to the of the matrix material 12 can affect the strength-to-weight ratio of the impact dissipating material 10. For example, increasing fluid volume generally increases both strength and weight, and vice-versa for less fluid volume. As such an optimal fill ratio (e.g., optimal strength-to-weight ratio) is dependent on the interpenetrating material 14 and cell structure characteristics of the matrix material 12, as well as on the dispersion methods described above.

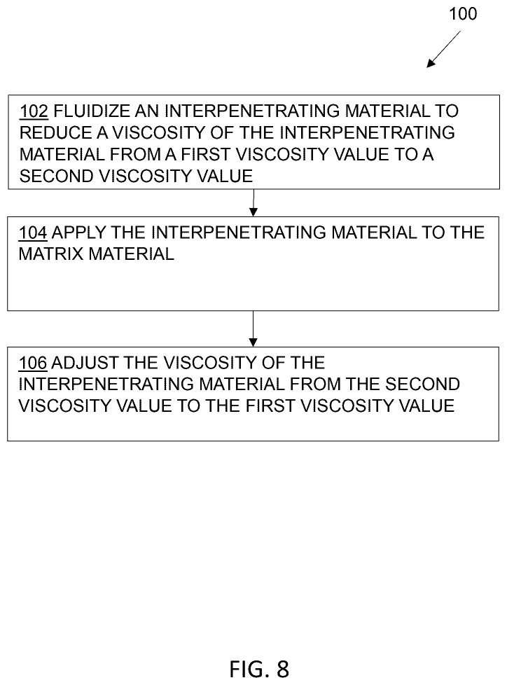

During the manufacturing process, relatively high viscosity interpenetrating materials 14 can be difficult to inject into the matrix material 12 without collapsing the cells 15, making fabrication of the impact dissipating material 10 difficult. FIG. 8 illustrates a flowchart 100 illustrating a method of manufacturing an impact dissipating material 10 having a relatively high viscosity interpenetrating material 14.

In element 102, a manufacturer fluidizes an interpenetrating material 14 to reduce a viscosity of the interpenetrating material 14 from a first viscosity value to a second viscosity value. The manufacturer can fluidize the interpenetrating material 14 in a number of ways. For example, the manufacturer can fluidize the interpenetrating material 14 by dissolution in a solvent or can apply heat to the interpenetrating material 14 to lower the viscosity of the interpenetrating material 14.

In element 104, the manufacturer can apply the interpenetrating material 14 to the matrix material 12. For example, in the case where the interpenetrating material 14 has been dissolved in a solvent, the manufacturer can inject the interpenetrating material 14 into the matrix material 12. In the case where the interpenetrating material 14 has been heated to lower its viscosity, the manufacturer can flow the interpenetrating material 14 into the cells 15 defined by the matrix material 12. Further, the manufacturer can adjust the geometry (e.g., size, shape, distribution, etc.) of the cells 15 in the matrix material 12 to allow for ease of introduction of the interpenetrating material 14 therein. Additionally, vacuum pressure can be applied to the matrix material 12 to pull the interpenetrating material 14 into the cells 15 or cavities 16.

In element 106, the manufacturer can adjust the viscosity of the interpenetrating material 14 from the second viscosity value to the first viscosity value. For example, in the case where the interpenetrating material 14 has been dissolved in a solvent, the manufacturer can evaporate the solvent by passive means or application of heat. In the case where the interpenetrating material 14 has been heated to lower its viscosity, the manufacturer can remove heat from interpenetrating material 14 to increase its viscosity to allow it to remain within the cells 15 defined by the matrix material 12. As such, during the manufacturing process the manufacturer can introduce the interpenetrating material 14 into the matrix material 12 while preserving a wall structure defining each cell 15 of the matrix material 12.

### EXPERIMENTAL RESULTS

As provided above, the matrix material 12 and interpenetrating material 14 of the impact dissipating material 10 are configured to work together in a synergistic manner to enhance overall impact-absorption behavior of the impact dissipating material 10 to provide dissipation of an impact load. The following provides example configurations of the impact dissipating material 10 having a variety of matrix material 12 and interpenetrating material 14 configurations, as well as the effect of these configurations on impact load dissipation.

Experiments have been conducted at high strain rates using a drop tower to simulate impact loading, with an example impact dissipating material 10 specimen (e.g., an individual element, as described previously) having a matrix material 12 configured as an open-cell aluminum 6101-T6 foam. The matrix material 12 is saturated with the interpenetrating material 14 such that the cells of the matrix material 12 are fully infiltrated.

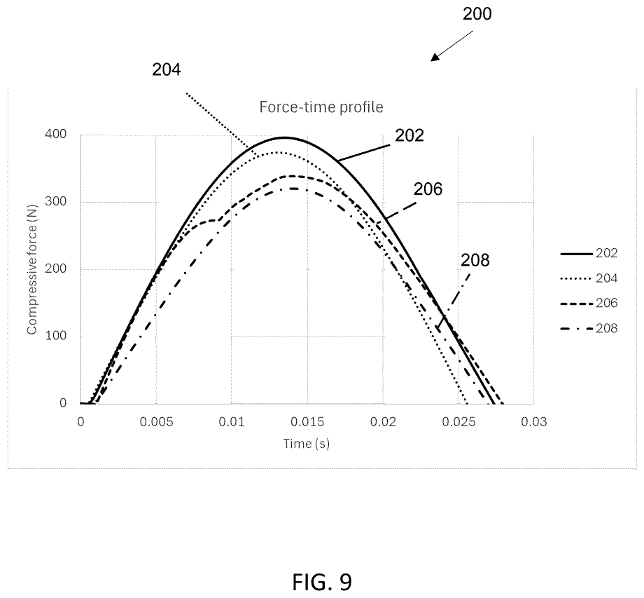

FIG. 9 is a graph 200 illustrating example mechanical test data showing force-time profiles experienced by an object protected by an impact dissipating material 10. A baseline condition 202 is depicted which shows a force-time profile of only the matrix material 12 and without inclusion of the interpenetrating material 14 and indicates the performance of pre-existing, conventional impact-absorbing systems. Additionally, FIG. 9 depicts force-time profiles 204, 206, 208 of impact dissipating materials 10 having the matrix material 12 and distinct constitutions of the interpenetrating material 14.

The mechanical testing data in FIG. 9 indicates that an improvement in force-time response 204, 206, 208 was made relative to the baseline condition 202 by the use of the impact dissipating material 10 having combined matrix material 12 and interpenetrating material 14. For example, the peak compressive force shown in curve 202 is 395 N, is 374 N in curve 204, is 338 N in curve 206, and is 320 N in curve 208. This indicates a substantial reduction in the peak force experienced by the shielded object by 5.5% in curve 204, 14.5% in curve 206, and 19.0% in curve 208.

While various embodiments of the innovation have been particularly shown and described, it will be understood by those skilled in the art that various changes in form and details may be made therein without departing from the spirit and scope of the innovation as defined by the appended claims.

What is claimed is:

1. An impact dissipating material, comprising:
a matrix material defining a plurality of cells; and
an interpenetrating material carried by the matrix material, the interpenetrating material disposed in a first position relative to the plurality of cells of the matrix material under a first loading condition and in a second position relative to the plurality of cells under a second loading condition.

2. The impact dissipating material of claim 1, wherein the matrix material is configured as a stochastic structure.

3. The impact dissipating material of claim 2, wherein the stochastic structure defines the plurality of cells as at least one of open cell structures and closed cell structures.

4. The impact dissipating material of claim 2, wherein the stochastic structure is further configured as a gradient structure.

5. The impact dissipating material of claim 1, wherein the matrix material defining the plurality of cells is configured as an architectural structure.

6. The impact dissipating material of claim 5, wherein the architectural structure defines the plurality of cells as at least one of open cell structures and closed cell structures.

7. The impact dissipating material of claim 5, wherein the architectural structure is further configured as a gradient structure.

8. The impact dissipating material of claim 1, wherein the interpenetrating material comprises at least one of a viscous fluid, a shear thickening fluid, a viscoelastic fluid, a viscoplastic fluid, or a viscoelastic solid.

9. The impact dissipating material of claim 8, wherein the interpenetrating material further comprises a strengthening mechanism configured to adjust a flow characteristic of the interpenetrating material relative to the matrix material.

10. The impact dissipating material of claim 1, wherein the interpenetrating material comprises a field responsive material.

11. The impact dissipating material of claim 10, wherein the field responsive material comprises at least one of a magneto-rheologic fluid, an electro-rheologic fluid, and a magneto-rheologic elastomer.

12. The impact dissipating material of claim 1, wherein the viscosity of the interpenetrating material carried by the matrix material maintains the interpenetrating material in the first position relative to the plurality of cells of the matrix material under the first loading condition.

13. The impact dissipating material of claim 1, wherein the matrix material defines a geometry configured to maintain the interpenetrating material in the first position relative to the plurality of cells of the matrix material under the first loading condition.

14. The impact dissipating material of claim 13, wherein the matrix material defines at least one cavity configured to maintain the interpenetrating material in the first position relative to the plurality of cells of the matrix material under the first loading condition.

15. The impact dissipating material of claim 13 wherein at least a portion of the plurality of cells defined by the matrix material encapsulate the interpenetrating material to maintain the interpenetrating material in the first position relative to the plurality of cells of the matrix material under the first loading condition.

16. An impact dissipation system, comprising:
a base; and
an impact dissipating material carried by the base, the impact dissipating material comprising:
a matrix material defining a plurality of cells; and
an interpenetrating material carried by the matrix material, the interpenetrating material disposed in a first position relative to the plurality of cells of the matrix material under a first loading condition and in a second position relative to the plurality of cells under a second loading condition.

17. The impact dissipation system of claim 16, wherein the interpenetrating material comprises at least one of a viscous fluid, a shear thickening fluid, a viscoelastic fluid, a viscoplastic fluid, or a viscoelastic solid.

18. The impact dissipation system of claim 17, wherein the interpenetrating material further comprises a strengthening mechanism configured to adjust a flow characteristic of the interpenetrating material.

19. The impact dissipation system of claim 16, wherein the interpenetrating material comprises a field responsive material.

20. A method of manufacturing an impact dissipating material while preserving a wall structure defining each cell of a matrix material, comprising:
fluidizing an interpenetrating material to reduce a viscosity of the interpenetrating material from a first viscosity value to a second viscosity value;
applying the interpenetrating material to the matrix material; and
adjusting the viscosity of the interpenetrating material from the second viscosity value to the first viscosity value.
